(19) United States
(12) Patent Application Publication
(10) Pub. No.: US 2021/0374537 A1
(43) Pub. Date: Dec. 2, 2021

(54) STRUCTURED CONVOLUTIONS AND ASSOCIATED ACCELERATION

(71) Applicant: QUALCOMM Incorporated, San Diego, CA (US)

(72) Inventors: Yash Sanjay BHALGAT, San Diego, CA (US); Fatih Murat PORIKLI, San Diego, CA (US); Jamie Menjay LIN, San Diego, CA (US)

(21) Appl. No.: 17/336,048

(22) Filed: Jun. 1, 2021

Related U.S. Application Data
(60) Provisional application No. 63/033,746, filed on Jun. 2, 2020.
(60) Provisional application No. 63/033,751, filed on Jun. 2, 2020.

(51) Int. Cl. G06N 3/08; G06F 17/15; G06F 17/16; G06N 3/04

(52) U.S. Cl. CPC G06N 3/08; G06N 3/04; G06F 17/16; G06F 17/153

(57) ABSTRACT

Certain aspects of the present disclosure provide techniques for performing machine learning, including generating a set of basis masks for a convolution layer of a machine learning model, wherein each basis mask comprises a binary mask; determining a set of scaling factors, wherein each scaling factor of the set of scaling factors corresponds to a basis mask in the set of basis masks; generating a composite kernel based on the set of basis masks and the set of scaling factors; and performing a convolution operation based on the composite kernel.

### CROSS-REFERENCE TO RELATED APPLICATIONS

This application claims the benefit of and priority to U.S. Patent Application No. 63/033,746, filed on Jun. 2, 2020, and U.S. Patent Application No. 63/033,751, filed on Jun. 2, 2020, the entire contents of each of which is incorporated by reference herein.

### INTRODUCTION

Aspects of the present disclosure relate to machine learning models.

Machine learning may produce a trained model (e.g., an artificial neural network, a tree, or other structures), which represents a generalize fit to a set of training data that is known a priori. Applying the trained model to new data produces inferences, which may be used to gain insights into the new data. In some cases, applying the model to the new data is described as “running an inference” on the new data.

Machine learning models are seeing increased adoption across myriad domains, including for use in classification, detection, and recognition tasks. For example, machine learning models are being used to perform complex tasks on electronic devices based on sensor data provided by one or more sensors onboard such devices, such as automatically detecting features (e.g., faces) within images.

A key challenge to widespread deployment and adoption of machine learning models is their computational complexity, which generally requires high-powered computing systems. Less powerful computing systems, such as mobile devices, wearable devices, Internet of Things (IoT) devices, edge processing devices, and others, may not have the resources necessary to implement machine learning models.

Accordingly, there is a need for more efficient machine learning methods.

### BRIEF SUMMARY

Certain aspects provide a method of performing machine learning, including: generating a set of basis kernels for a convolution layer of a machine learning model, wherein each basis kernel comprises a mask and a scaling factor; generating a composite kernel based on the plurality of basis kernels; and performing a convolution operation based on the composite kernel.

Further aspects provide a method for performing machine learning, including: generating a set of basis kernels for a convolution layer of a machine learning model, wherein each basis kernel comprises a binary mask; determining a set of scaling factors, wherein each scaling factor of the set of scaling factors corresponds to a basis kernel in the set of basis kernels; generating a sum-pooled output based on input data to the convolution layer of the machine learning model; and generating a convolution layer output based on the sum-pooled output and the set of scaling factors.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIGS. 1A-1D depict examples of forming two-dimensional composite kernels from basis kernels.

FIGS. 2A-2B depict examples of forming structured kernels from structured basis kernels.

FIG. 3 depicts an example of cross-stride sum sharing.

FIG. 4 depicts an example decomposition of a convolution operation with a structured kernel using sum-pooling.

FIG. 5A depicts a three-dimensional structural decomposition of a structured convolution.

FIG. 5B depicts a two-dimensional structural decomposition of a structured convolution.

FIG. 6 depicts an example of decomposing a fully connected layer using a sum-pooling operation.

FIG. 7A depicts an example of an overlapping sum matrix.

FIG. 7B depicts an example algorithm for generating the overlapping sum matrix of FIG. 7A.

FIG. 8 depicts an example flow for achieving structural decomposition during training using a structural regularization term.

FIG. 9 depicts an example of a hardware accelerator for performing structured convolution.

FIG. 10 depicts an example processing pipeline that may be implemented with the hardware accelerator of FIG. 9.

FIG. 11 depicts an example method of performing machine learning in accordance with various aspect described herein.

FIG. 12 depicts an example method of performing machine learning in accordance with various aspect described herein.

FIG. 13 depicts an example processing system for performing machine learning in accordance with various aspects described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums performing and accelerating structured convolutions.

Deep neural networks deliver excellent performance across a variety of use-cases, but quite often fail to meet the computational budget requirements of day-to-day devices. Hence, model efficiency plays a key role in in the ability to implement deep neural network-based machine learning models in various contexts.

Conventional approaches for reducing deep neural network model size and complexity have included model compression techniques, which rely on a key assumption that the deep networks are over-parametrized—meaning that a significant proportion of the deep neural network model's parameters are redundant. Based on this assumption, several model pruning methods have been proposed that systematically remove redundant components in the deep neural network model to improve run-time efficiency. Other approaches for exploiting redundancy and reducing complexity include tensor decomposition based on the singular values of the weight matrices, such as spatial singular value decomposing (SVD) and weight SVD.

Redundancy in deep neural networks models can also be seen as the network weights possessing unnecessary degrees of freedom (DOF). From an optimization point of view, higher DOF can lead to overfitting, which may be addressed using various regularization methods to constrain the network weights.

Another way of reducing the DOF is by reducing the number of learnable parameters. For example, basis representations may be used in place of weight tensors. In such methods, the basis vectors are fixed and only the coefficients of these basis vectors are learnable. Hence, by using fewer coefficients than the actual number of parameters in the weight tensors, the DOF can be restricted. However, note that this is useful only during training, since the actual (higher) number of parameters are used during inference. That said, systematically choosing the basis (e.g. the Fourier-Bessel basis) can lead to model parameter reduction and floating point operations per second (FLOPS) reduction even during inference time.

Embodiments described herein improve deep neural network model efficiency by restricting the degrees of freedom of convolutional kernels (or filters) and imposing an explicit structure on them. This structure can be thought of as constructing the convolution kernel by super-imposing several lower-resolution kernels, which may be referred to as basis kernels, each defined by a basis mask and a scaling factor.

Notably, the methods described herein exploit the fact that multiplication operations are generally more computationally expensive than additions (e.g., 20 or more times as expensive). Thus, the methods described herein reach mathematically equivalent outputs with greatly reduced multiplication operations, and generally reduced addition operations as well. Notably, these methods produce the general benefits of model size reduction (e.g., by reducing parameter count) and increase model computational efficiency (e.g., by reducing the number of operations) while processing the model during training and inference.

Embodiments described herein realize the benefits over conventional model compression methods in various aspects. For example, embodiments described herein may utilize composite kernel structures, which accept an arbitrary basis in the kernel formation, leading to an efficient convolution operation.

Further, embodiments described herein may utilize structured convolutions as a realization of composite kernel structures. In particular, structured convolution can be decomposed into a sum-pooling operation followed by a significantly smaller convolution operation, which decreases the number of model parameters (and thus model size) as well as reduces the number of multiplication operations needed during model processing, which decreases computation complexity. Beneficially, this decomposition method can be applied to convolutional layers of a deep neural network model as well as to fully connected/linear layers in such models.

Further, embodiments described herein may use structural regularization methods during training to promote convolution weights to have the desired structure, which facilitates the decomposition methods described herein. Thus, the structural regularization methods described herein beneficially lead to more effective decomposition with minimal loss in accuracy.

Further, embodiments described herein may utilize a hardware-based accelerator to implement efficient sum-pooling operations, including cross-kernel sum sharing and cross-stride sum sharing.

### 2-D and 3-D Composite Kernels

Generally, the structure of a composite kernel may be determined by an underlying basis mask set [symbol] , which may be referred to as a composite basis mask. For example, for [symbol] ^{N×N}, a basis mask set [symbol] ={β₁, β₂, . . . , β_{M}} may be constructed such that every basis mask, βᵢ, i∈{1, . . . , M}, is a mask (e.g., a binary mask) of dimension N×N, and the set [symbol] is linearly independent, such that:

βₘ∈ [symbol] ^{N×N},βₘ_{ᵢⱼ}∈{0,1}∀i,j∈{1, . . . ,N}, and

Σₘ₌₁^{M}αₘβₘ=0⇔∀m,αₘ=0.

Each individual basis element may be further represented for m∈{1, . . . , M} as βₘ [symbol] {φᵢⱼ} with i∈{1, . . . , N}, j∈{1, . . . , N}, and φᵢⱼ∈{1, 0}.

Notably, each of the basis masks βᵢ in the composite basis mask [symbol] is not necessarily orthogonal to the other basis masks. Also, the linear independence condition automatically implies that M≤N². Hence, the basis set [symbol] spans only a subspace of [symbol] ^{N×N}.

Further, given a set of scaling factors α [symbol] {α₁, α₂, . . . , α_{M}} and (partial) activation X [symbol] {xᵢⱼ} with i,j∈{1, . . . , N}, the convolution for the associated central feature is computed as Y [symbol] W⊙X, where “⊙” stands for sum of element-wise multiplications, and W [symbol] Σₘαₘβₘ is the N×N kernel.

Accordingly, a kernel W of dimension N×N is said to be a two-dimensional (2-D) composite kernel if it can be constructed as a linear combination of a composite basis, such that:

WΣₘ₌₁^{M}αₘβₘ for some α=[α₁, . . . ,α_{M}],

where αₘ is a scaling factor for the mth basis mask βₘ, and αₘβₘ forms the basis kernel.

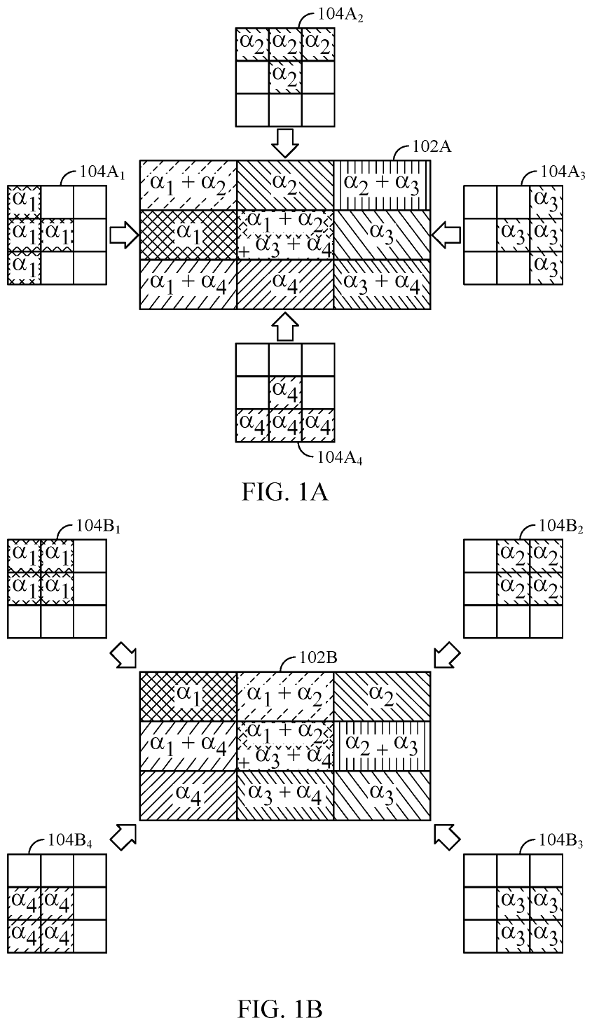

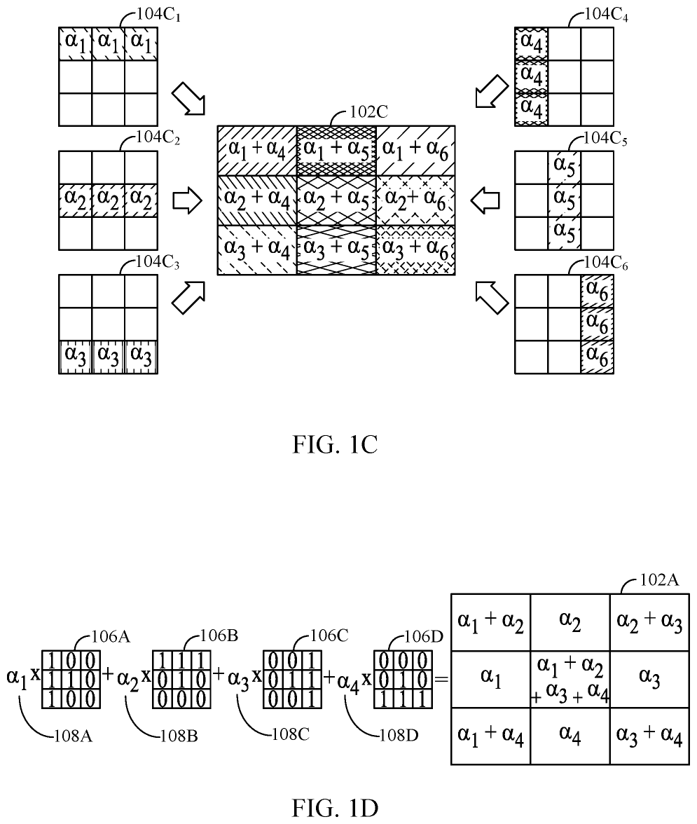

FIGS. 1A-1C depict examples of a 3×3 composite kernel constructed using different sets of basis kernels. In particular, composite kernels 102A-C in FIGS. 1A-1C, respectively, are constructed via a superimposition of M basis kernels 104A-C, respectively, where M=4 in FIGS. 1A and 1B and M=6 in FIG. 1C. Each of the basis kernels 104A-C is formed by applying a constant scaling factor, αₘ, where m∈{1 . . . M}, to a binary basis mask, βₘ, hence leading to M degrees of freedom for the composite kernels 102A-C.

FIG. 1D depicts the same composite kernel 102A shown in FIG. 1A as a linear combination of binary basis masks 106A-D (e.g., βₘ) and associated scaling factors 108A-D (e.g., αₘ).

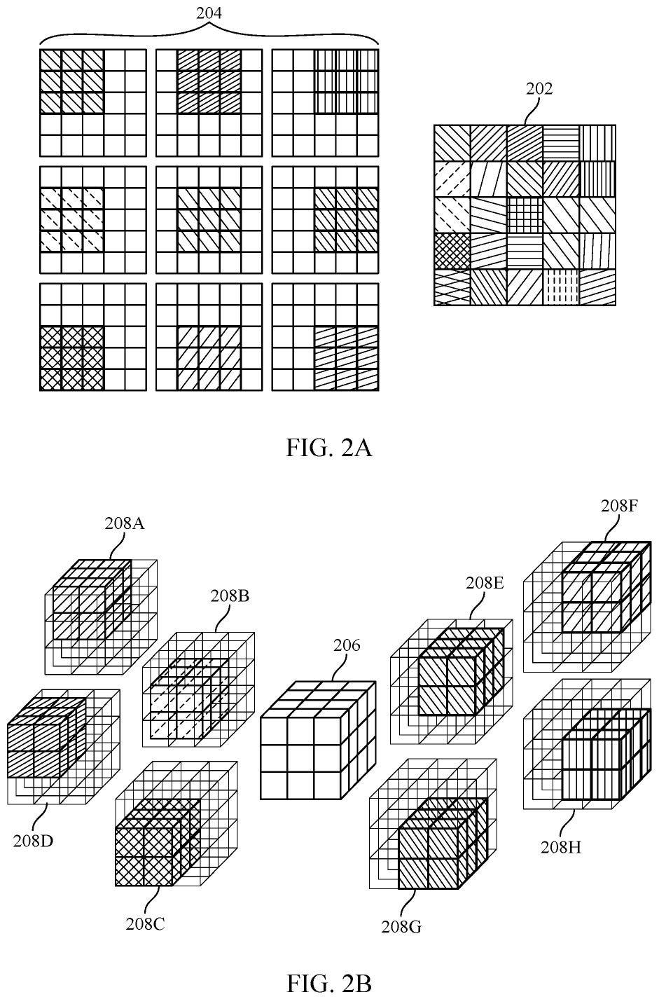

FIG. 2A depicts another example in which a 5×5 composite kernel 202 is constructed based on nine basis kernels 204 (shown without their associated scaling factors).

In general, the underlying basis kernels may have different and less regular structure than what is demonstrated in the examples of FIGS. 1A-1D and 2A-2B. In particular, if the kernel size N is large, there are myriad decompositions possible. Even with, for example, N=5, the 5×5 kernel can be decomposed in many ways, including: multiple 2×2 basis kernels, multiple 3×3 basis kernels, or a mixture of 2×2 and 3×3 basis kernels, to name just a few options.

Composite kernels can likewise be used in a three-dimensional (3-D) case. For example, a composite basis mask [symbol] may be defined for [symbol] ^{C×N×N} wherein each basis mask, βₘ, is a mask (e.g., a binary mask) of dimension C×N×N. A kernel W of dimension C×N×N is then a three-dimensional composite kernel if it is a linear combination such basis kernels. Thus, two-dimensional composite kernels may be considered a special case of three-dimensional composite kernels where C=1. FIG. 2B depicts an example of constructing a 4×3×3 composite kernel 206 with eight basis kernels 208, each having a 3×2×2 dimensionality.

### Convolution with Composite Kernels

Consider a convolutional layer with a composite kernel, W, having a size of C×N×N, where N is the spatial size (e.g., a number of vertical and horizontal pixels in in a receptor field of the kernel) and C is the number of input channels for the convolution layer (e.g., color layers in an image). Generally, the composite kernel W may be constructed using M basis kernels, such as depicted in the examples of FIGS. 1A-1D and 2A-2B.

To compute an output of the convolution layer, the composite kernel is applied to a C×N×N volume of an input feature map, X. Hence, the output Y at this point is:

$$\begin{matrix}Y = X ⊙ W \\ = X ⊙ {\sum }_{m = 1}^{M} {α}_{m} {β}_{m} \\ = {\sum }_{m = 1}^{M} {α}_{m} ( X ⊙ {β}_{m} ) \\ = {\sum }_{m = 1}^{M} {α}_{m} sum ( X • {β}_{m} ) \\ = {\sum }_{m = 1}^{M} {α}_{m} {E}_{m}\end{matrix} \qquad ( 1 )$$

In the preceding derivation of Equation 1, ‘⊙’ indicates a sum of element-wise multiplication (e.g., a convolution operation), ‘·’ indicates an element-wise multiplication, and Eₘ=sum(X·βₘ).

Now, in the case that each βₘ is a binary mask of 0's and 1's, sum(X·βₘ) is then equivalent to summing the elements of X wherever βₘ=1.

Thus, the convolution operation with a composite kernel can be decomposed into the following steps.

Step 1: use βₘ as a matrix mask to extract entries of X corresponding to the non-zero entries of βₘ and discard other entries.

Step 2: Compute Eₘ [symbol] βₘ⊙X=sum(βₘ·X) by summing all non-zero entries of βₘ·X. As used herein, Eₘ may be referred to as a basis sum. As above, in this example, the elements of βₘ are either 0 or 1.

Step 3: Compute Y=W⊙X=(Σₘ αₘβₘ)⊙X=Σₘ αₘEₘ=α⊙E, where α={α₁, α₂, . . . , α_{M}} and E [symbol] {E₁, E₂, . . . , E_{M}} are both vectors, and “⊙” reduces into an inner product. Note that αₘEₘ may be referred to as a partial convolution output based on the basis kernel m.

Conventionally, this convolution would involve CN² multiplications and CN²−1 additions. However, from Equation 1, it is apparent that only M multiplications are needed, and the total number of additions becomes:

$$\begin{matrix}Num Additions = {\sum }_{m = 1}^{M} \underbrace{( sum ( {β}_{m} ) - 1 )}_{from sum ( X • {β}_{m} )} + \underbrace{( M - 1 )}_{from \sum {α}_{m} {E}_{m}} \\ = {\sum }_{m = 1}^{M} sum ( {β}_{m} ) - 1\end{matrix} \qquad ( 2 )$$

The number of multiplications has thus been reduced because M≤CN². Beneficially, the reduction in multiplications based on the use of composite kernels results in a proportional reduction in complexity, which in-turn means that the underlying model will run faster during training and inferencing operations. Further, less power will be used when performing either type of operation, which is particularly beneficial for deployment of machine learning models in low-power devices, such as mobile devices.

According to Equation 2, additions can sometimes become larger than CN²−1. For example, in FIG. 1B, where C=1, N=3, M=4, Σₘ sum(βₘ)−1=4+4+4+4−1=15>CN²−1=8.

In addition to reducing the number of operations performed in convolution operations, composite kernels also beneficially reduce model size. With conventional convolution kernels, C*N² parameters need to be stored, whereas with composite kernels, only M parameters need to be stored, where M<C*N² by construction. Hence, the model size decreases by a factor of

$$\frac{M}{C * {N}^{2}} .$$

This reduction in size beneficially reduces memory requirements, memory read and write operations and the associated power and latency, and communication costs across local busses and across networks.

### 2-D and 3-D Structured Kernels

Structured kernels are a special case of composite kernels, and convolutions performed with structured kernels may be referred to as “structured convolutions.”

In a two-dimensional example, an N×N kernel may be referred to as “structured” if it is a composite kernel (as described above) with M=k² for some 1<k≤N, and if each basis kernel βₘ is made of a (N−k+1)×(N−k+1) patch of 1's, while the remainder of its elements are 0. Hence, a 2D structured kernel is characterized by its dimension N and its underlying parameter k.

For example, FIG. 2A depicts an example case of a 5×5 composite kernel 202 constructed with nine basis kernels 204 (again, the scaling factors are not depicted). Thus, in this example, N=5 and k=3, which means N−k+1=3 and M=k²=9 basis kernels. Each basis kernel has a (N−k+1)×(N−k+1)=3×3 sized patch of 1's (e.g., binary mask). Similarly, FIG. 1B also depicts an example of a 3×3 structured kernel where M=4 and each basis kernel has a 2×2 patch of 1's.

Structured kernels beneficially reduce complexity and model size. In a conventional convolution with a two-dimensional kernel, the number of multiplications and additions is N² and N²−1, respectively. By contrast, with a structured two-dimensional kernel, the number of multiplications decrease from n²→k², and the number of additions becomes:

((N−k+1)²−1)*k²+k²−1=(N−k+1)²*k²−1.

Similarly, whereas a conventional two-dimensional convolution kernel needs to store N² values, a structured two-dimensional kernel needs only to store k² values, where 1<k≤N. Hence, the model size decreases by a factor of k²/n².

Similarly, a C×N×N kernel (i.e., a three-dimensional kernel) may be considered “structured” if it is a composite kernel with M=Dk² for some 1<k≤N, 1<D≤C, and each basis kernel βₘ is made of a (C−D+1)×(N−k+1)×(N−k+1) patch of 1's (or mask) while the remainder of its elements are 0. Hence, a three-dimensional structured kernel is characterized by its dimensions C, N and its underlying parameters D, k.

FIG. 2B depicts an example where C=4, N=3, D=2, and k=2, which means C−D+1=3 and N−k+1=2. Hence, as shown, there are M=Dk²=8 basis kernels 208A-208H that are used to construct the structured kernel 206, and each basis kernel 208A-208H has a (C−D+1)×(N−k+1)×(N−k+1)=3×2×2 sized patch of 1's. Here again, the scaling factors associated with each basis kernel 208A-208H are not depicted.

Structured kernels can thus further reduce mathematical operations and further increase the efficiency of model processing compared to composite kernels (as they are a special case of composite kernels).

For example, using conventional convolution, the number of multiplications and additions with a three-dimensional kernel is C*n² and C*n²−1, respectively. By contrast, with a three-dimensional structured kernel, the number of multiplications decrease from C*n²→D*k² and the number of additions becomes ((C−D+1)(n−k+1)²−1)*D*k²−1 in the worst case, though in practice the number of additions may be even smaller. Further, only D*k² values need to be stored per structured kernel instead of C*n² values in the conventional case, which means that the model size decreases by a factor of:

$$\frac{D * {k}^{2}}{C * {n}^{2}} .$$

This decrease in model size means reduced memory requirements, reduced power use (e.g., for moving values in an out of memory), and faster processing because of the greatly reduced number of operations, including multiplications and additions.

Notably, standard convolution, depthwise convolution, and pointwise convolution kernels can be constructed as three-dimensional structured kernels, which means that the efficiency gains from such kernels can be widely applied to existing deep neural network model architectures.

### Cross-Kernel Sum Sharing

Composite kernels, including structured kernels, enable various additional efficiency gains during convolution operations, including sum-pooling operations. Sum-pooling generally refers to the ability to reuse summations across multiple kernels and/or strides of a convolution operation without recalculating the summation in multiple successive operations. Mathematically, a sum-pooling operation on input X may defined as calculating the outputs {X*β₁, . . . , X*β_{M}}. Cross-kernel sum-sharing is one method of performing sum-pooling.

For example, as depicted in FIGS. 1A-1D and 2A-2B, basis kernels may act on the same input data, and thus certain computations are unnecessarily repeated. By avoiding the redundant computations, computational efficiency is improved.

To illustrate this concept, consider a convolutional layer with Cₒᵤₜ number of kernels and thus Cₒᵤₜ number of output channels. Notably, each of these kernels operate on the same feature map X. Since the same basis (e.g., [symbol] ={β₁, . . . , β_{M}}) is used for all the kernels in a layer, consider two convolutional kernels in a layer: W₁=Σₘ αₘ¹βₘ and W₂=Σₘ αₘ² βₘ. The convolution operation with these kernels is as follows:

$${Y}_{1} = {W}_{1} ⊙ X = {\sum }_{m} {α}_{m}^{( 1 )} ( {β}_{m} ⊙ X ) , \\ {Y}_{2} = {W}_{2} ⊙ X = {\sum }_{m} {α}_{m}^{( 2 )} ( {β}_{m} ⊙ X )$$

Thus, for each of the kernels W₁ and W₂, the βₘ⊙X computation is common and can be stored into a buffer for reuse to avoid re-computation. In other words, the sum can be shared across kernels.

Notably, for structured convolutions, due to the explicit structure of the basis kernels βₘ, the computation βₘ⊙X is a sum-pooling operation.

Cross-kernel sum sharing may be implemented in various ways in processing hardware. For example, a processing system may calculate all of the sum-pooled outputs for an entire input X and store these outputs in a buffer. This buffer may then be consumed by all of the Cₒᵤₜ kernels.

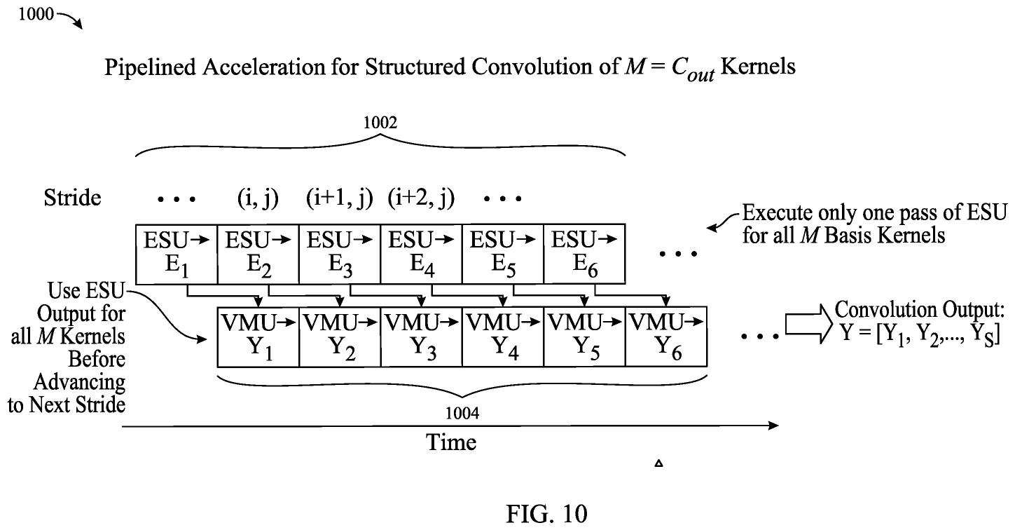

As another example, a processing system may compute one stride of the sum-pooled output and then consume it for all the Cₒᵤₜ kernels, and repeat this streaming computation for all strides, as described in more detail below with respect to FIG. 10. Notably, this streaming approach may beneficially require less activation buffer memory and may also reduce the latency and power cost of data input and output (e.g., writing to and reading from the activation buffer).

### Cross-Stride Sum Sharing

Similar to the concept of avoiding redundant computations between basis kernels operating on the same input data, redundant computations can be avoided when applying a structured kernel to strided input data.

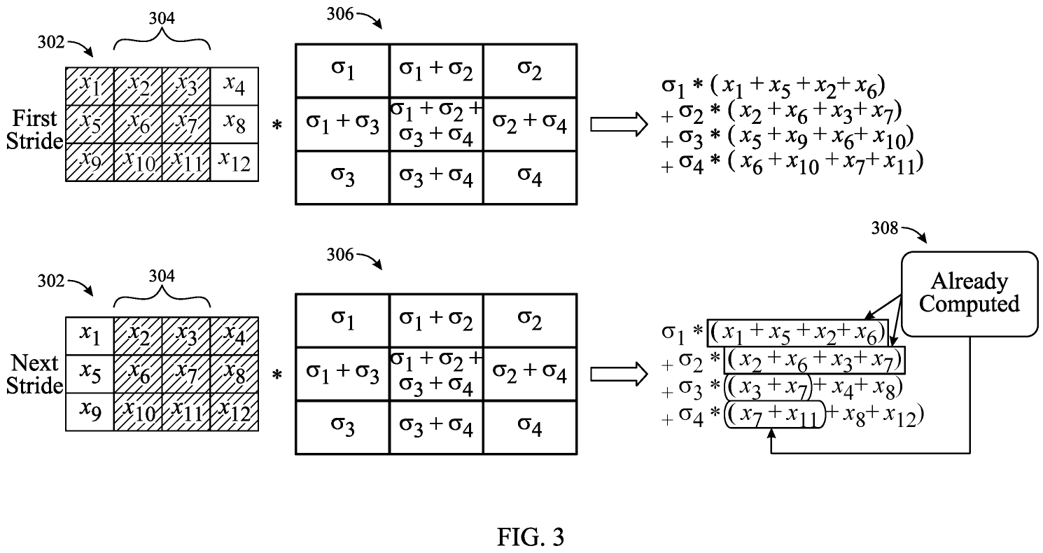

FIG. 3 depicts an example of cross-stride sum sharing. In particular, it is apparent that the middle two columns 304 of the input data 302 are processed in the first stride and the second stride by structured kernel 306. Therefore, a subset of the operations 308 need not be repeated between strides, which beneficially saves multiplication and addition operations.

Cross-stride sum sharing is another example of a sum-pooling operation.

### Decomposition of a Convolution Operation with Structured Kernels and Sum-Pooling

A convolution operation with a structured kernel can be decomposed into a sum-pooling operation and a smaller convolution operation.

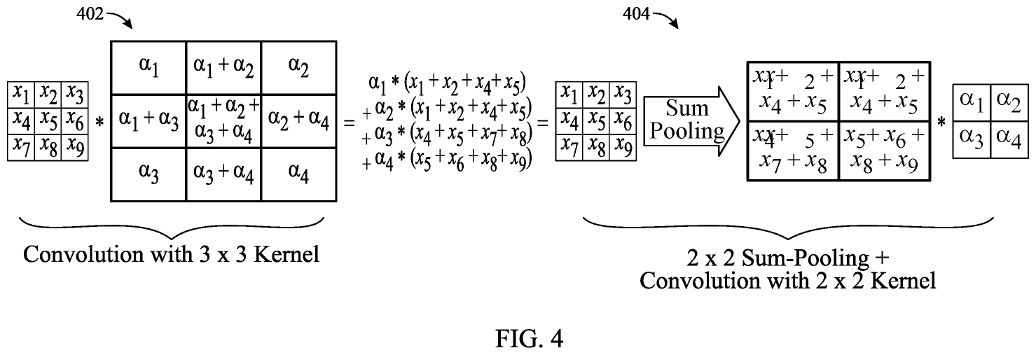

Consider a convolution with a 3×3 structured kernel with k=2. FIG. 4 shows how the conventional 3×3 convolution 402 can be broken into a 2×2 sum-pooling operation followed by a 2×2 convolution with a kernel made of αᵢ's, which may be referred to generally as a decomposed convolution 404.

From Equation 1, above, it is known that X⊙W=Σₘ αₘ(X⊙βₘ). Since in this example the basis mask βₘ is made of a contiguous patch of 1's, a convolution with the basis masks βₘ, m∈(1 . . . M}, is a sum-pooling operation because each βₘ has a patch of 1's in a particular position in the C×N×N grid, and X⊙βₘ corresponds to a particular stride of the sum-pooling operation.

Consider a single stride of the convolution X⊙W, which can be broken down into two parts. First compute all the sum-pooled outputs: {X⊙β₁, X⊙β₂, . . . , X⊙β_{M=Dk}_{²}} (note: M=Dk²). This is basically performing a (C−D+1)×(N−k+1)×(N−k+1) sum-pooling (with stride 1) on the input X. Second, perform the convolution on the sum-pooled output using a D×k×k kernel formed using the corresponding αᵢ's={α₁, α₂, . . . , α_{Dk}_{²}}.

Though the preceding example considers only a single stride of the convolution operation X⊙W, the decomposition holds even when an entire convolution operation is considered together, or in other words when considering all strides together and all Cₒᵤₜ kernels of a convolution layer together.

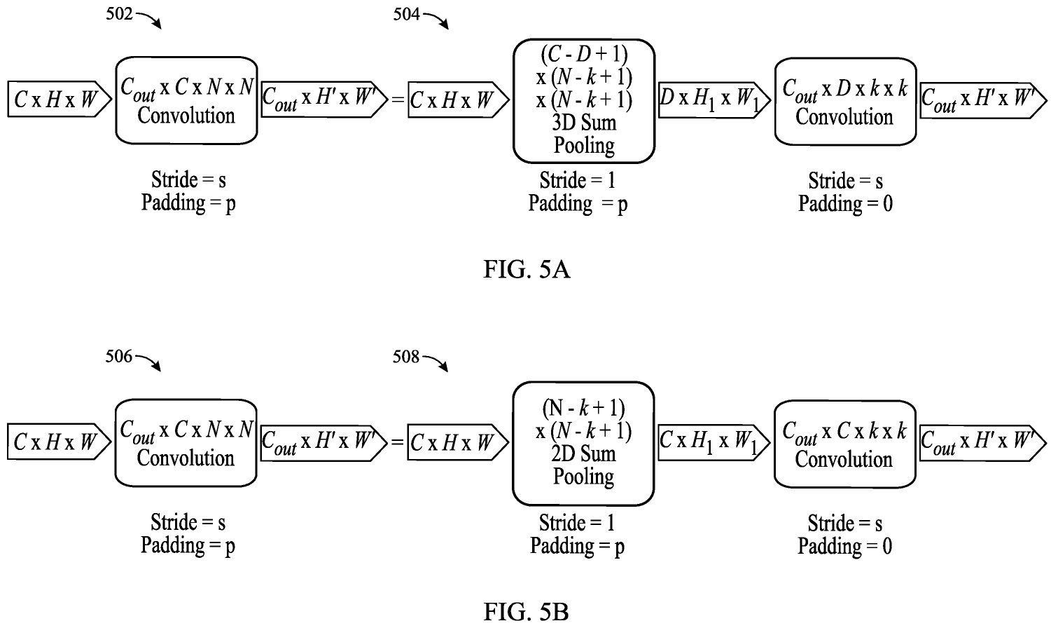

For example, FIG. 5A compares a conventional convolution 502 of C×H×W input with a C×N×N kernel to a decomposed structured convolution 504 with underlying parameters {D, k} and Cₒᵤₜ output channels. Notably, the output of each operation is mathematically equivalent, but the decomposed structured convolution 504 is significantly more efficient computationally and in terms of memory usage.

Using FIG. 5A as a reference then, the number of parameters and operations before and after the decomposition can be compared, as in Table 1, below:

TABLE 1

| | Conventional | Sum-pooling + smaller |
|---|---|---|
| | convolution (before | convolution (after |
| | decomposition) | decomposition) |
| # Parameters | CₒᵤₜCN² | CₒᵤₜDk² |
| # Multiplications | CN² × CₒᵤₜH′W′ | Dk² × CₒᵤₜH′W′ |
| # Additions | (CN² − 1) × CₒᵤₜH′W′ | ((C − D + 1)(N − |
| | | k + 1)² − 1) × DH₁W₁ + |
| | | (Dk² − 1) × CₒᵤₜH′W′ |

Because a two-dimensional structured kernel is a special case of a three-dimensional structured kernel where C=D=1, FIG. 5B shows how the two-dimensional structural decomposition 508 may be similarly implemented based on a conventional two-dimensional convolution 506.

Notably, the number of parameters and number of multiplications have both been reduced by a factor of Dk²/CN². This is because the sum-pooling component does not involve any multiplications. Further, the number of additions after decomposition can be rewritten as:

$${C}_{o u t} ( \frac{( C - D + 1 ) {( N - k + 1 )}^{2} - 1 ) \times D {H}_{1} {W}_{1}}{{C}_{o u t}} + ( D {k}^{2} - 1 ) \times {H}^{′} {W}^{′} )$$

Hence, if Cₒᵤₜ is large enough, the first term inside the parentheses gets amortized and the number of additions becomes ≈(Dk²−1)×CₒᵤₜH′W′. As a result, the number of additions also gets reduced by approximately the same proportion≈Dk²/CN². Thus, Dk²/CN² may be referred to as a structural decomposition compression ratio.

### Structural Decomposition in Linear or Fully Connected Layers

For a number of image classification networks, the last linear (or fully-connected) layer dominates in the number of parameters, especially if the number of classes is high. Beneficially, structural decomposition, as described above, can be extended to linear layers by the realization that performing a matrix multiplication is the same as performing a number of 1×1 or pointwise convolutions on the input.

Consider a matrix W∈ [symbol] ^{P×Q} and and input vector X∈ [symbol] ^{Q×1}. The linear operation Y=WX is the same as the pointwise convolution operation Y=unsqueezed(X)⊙unsqueezed(W), where unsqueezed(X) uses the same input data, X, but with dimensions Q×1×1 and unsqueezed(W) uses the same weights, W, but with dimensions P×Q×1×1. In other words, each row of W can be considered a pointwise convolution kernel of size Q×1×1.

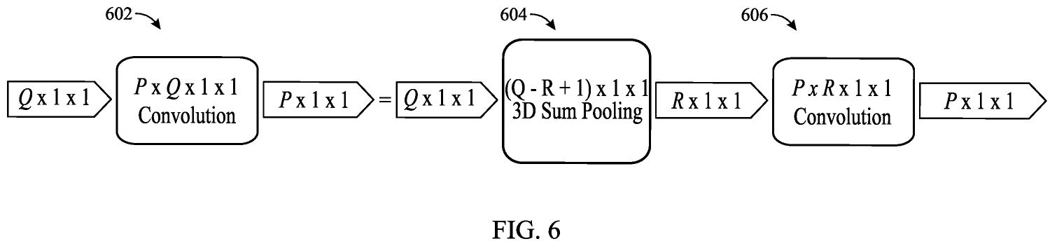

Hence, if each of these kernels (of size Q×1×1) is a structured kernel with some underlying parameter R, where 0<R≤Q, then the matrix multiplication/pointwise convolution operation 602 can be decomposed into a sum-pooling operation 604 and a smaller convolution 606 as depicted in FIG. 6.

As before, as a result of this decomposition, there is a beneficial reduction in both the number of parameters and number of multiplications by a factor of R/Q, and the number of additions decrease by a factor of

$$\frac{R ( Q - R ) + ( P R - 1 ) P}{( P Q - 1 ) P} .$$

### Imposing Structural Constraints on Convolution Kernels

As discussed above, if a convolution kernel is structured (e.g., is a composite kernel with particular structured basis kernels), then the convolution operation can be decomposed into a sum-pooling operation followed by a smaller convolution operation. Several methods may be used to impose the structured property on the convolution kernels in a deep neural network model during training.

A first method is to view the structural decomposition as a linear operation mapping the smaller D×k×k kernel made of αᵢ's to the original bigger C×N×N kernel W.

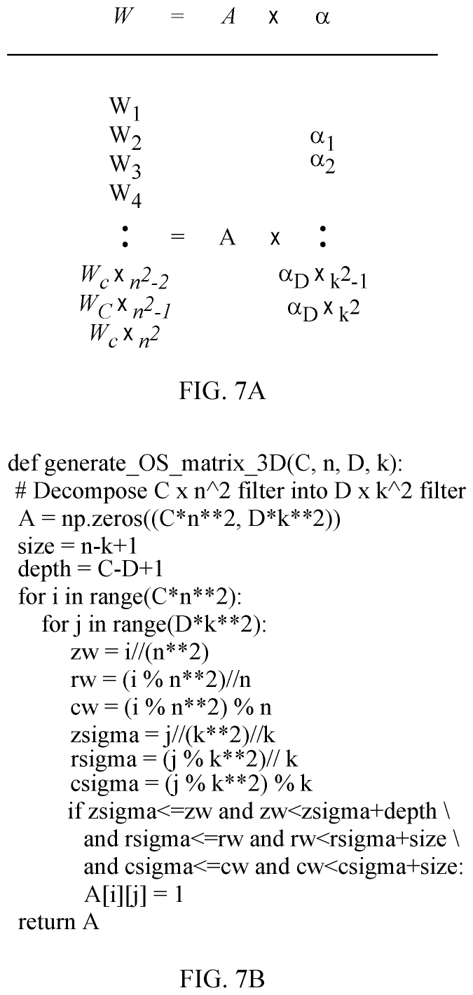

Initially, let W=Σₘ₌₁^{Dk}^{²} αₘβₘ, so a matrix A of size CN²×Dk² can be defined where the i^{th} column of A is the vectorized form of the basis mask βᵢ. Then, vectorized(W)=A×α, where α=[α₁, α₂, . . . , α_{Dk}_{²}] is the vectorized form of the smaller D×k×k kernel made of the scaling factors α. An example is depicted in FIG. 7A. Notably, this holds for all composite kernels, not just structured kernels.

Further, from the structural decomposition, it is known that a structured convolution can be decomposed into a sum-pooling operation followed by a smaller convolution operation. Note that sum-pooling can also be seen as a convolution with a kernel made of all 1's. This particular kernel may be referred to as 1_{(C-D+1)×(N-k+1)×(N-k+1)} where (C−D+1)×(N−k+1)×(N−k+1) is the kernel size of the sum-pooling. Now, the structural decomposition can be written as follows:

X*W=X*1_{(C-D+1)×(N-k+1)×(N-k+1)}*α_{D×k×k}

Thus, W=1_{(C-D+1)×(N-k+1)×(N-k+1)}*α_{D×k×k}, and the stride of the sum-pooling involved in the structural decomposition is 1. Hence, this convolution operation can be written in terms of matrix multiplication with a Toeplitz matrix as follows:

vectorized(W)=Toeplitz(1_{(C-D+1)×(N-k+1)×(N-k+1)})×vectorized(α_{D×k×k})

Accordingly, the A matrix referred to above is:

Toeplitz(1_{(C-D+1)×(N-k+1)×(N-k+1)}).

An example algorithm for generating this A matrix is depicted in FIG. 7B.

A second method is to train the model with a structural regularization term.

For example, if a kernel W of size C×N×N is structured with parameters D and k, there should exist a Dk² length vector a such that W=A×α, where A is Toeplitz(1_{(C-D+1)×(N-k+1)×(N-k+1)}), The corresponding α can be computed as α*=A⁺W, where A⁺ stands for the pseudo-inverse of A. This means, a structured kernel W satisfies the property: W=AA⁺W.

Based on this, a structural regularization loss term may be used which gradually imposes this structured property on a deep neural network's layers during training. The following is an example loss function for a structural regularization term:

$${t o t a l}_{} = {t a s k}_{} + λ {Σ}_{l = 1}^{L} \frac{{‖ ( I - A {A}^{+} ) {W}_{l} ‖}_{F}}{{‖ {W}_{l} ‖}_{F}} \qquad ( 3 )$$

In Equation 3, above, [symbol] ₜₐₛₖ stands for the task loss (e.g., cross-entropy in the case of image classification), ∥⋅∥_{F} stands for the Frobenius norm, and l is the layer index.

The equation (I−AA⁺)W=0 has a trivial solution at W=0. Hence, if only ∥(1−AA⁺)W∥_{F} is used as the regularization term, the optimization will disproportionately push the weights of larger layers to zero. To avoid this, ∥W∥_{F} is used in the denominator of the regularization term, which stabilizes the performance of the final deep network with respect to the choice of λ.

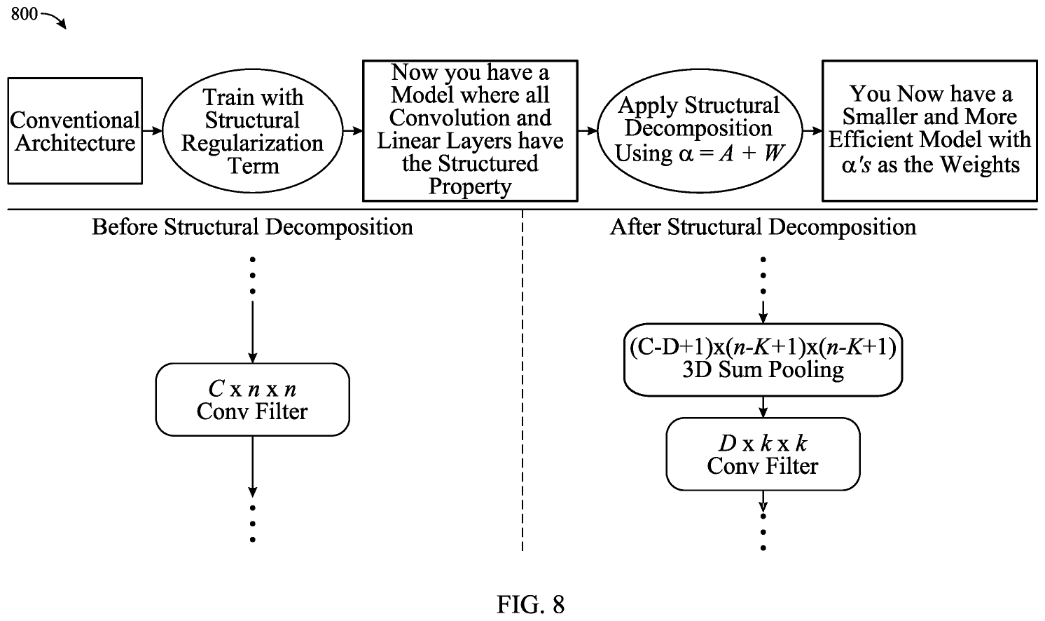

An example training method 800 is depicted in FIG. 8. If (I−AA⁺)W=0 for all kernels, then the decomposition α=A⁺W is “exact”, meaning that the decomposed architecture (with α's as weights) is mathematically equivalent to the original architecture before decomposition.

The structural regularization term also imposes a restrictive Dk² degrees of freedom while training, but it does so in a configurable manner (depending on λ). For example, if λ=0, it is the same as normal training with no structure imposed. Hence, at the end of training, the kernels will not have the structured kernel property and the structural decomposition will not be exact, thus degrading the model's performance. If λ is very high, the optimization process will try to heavily minimize the structural regularization loss before starting to optimize for the task loss. Hence, this becomes equivalent to the third and fourth method, discussed below. Accordingly, choosing a moderate λ gives the best tradeoff between structure and model performance.

Third, the original conventional architecture may be trained without any structural regularization, i.e., normal training with the task loss. However, at the end of normal training, the layers of the deep neural network model may be decomposed using α=A⁺W, and the decomposed architecture can then be fine-tuned.

Fourth, the decomposed architecture (made of the D×k×k kernels) may be trained from scratch.

In the third method and fourth method, during fine-tuning, the kernels possess Dk² degrees of freedom (instead of CN²). Hence, the optimization process is constrained in terms of degrees of freedom and the weights are optimized in a Dk² dimensional subspace of [symbol] ^{CN}^{²}. This may lead to lower performance of the decomposed architecture than using the structural regularization term method.

### Hardware Acceleration for Structured Convolutions

The preceding description sets forth the theoretical basis for significant computational complexity improvements through reduced numbers of mathematical operations using structured convolutions. In order to ensure that these theoretical improvements are realized in hardware, an accelerator may be used to implement efficient sum-pooling operations. Generally, such an accelerator may be realized, for example, in the form of specialized processing units of an application-specific integrated circuit (ASIC) chip, or as instructions or an extension unit of a software programmable neural processing unit (NPU), a neural signal processor (NSP), an artificial intelligence core (AIC), a digital signal processor (DSP), a central processing unit (CPU), a graphics processing unit (GPU), or other processing units, such as on a system on a chip (SoCs).

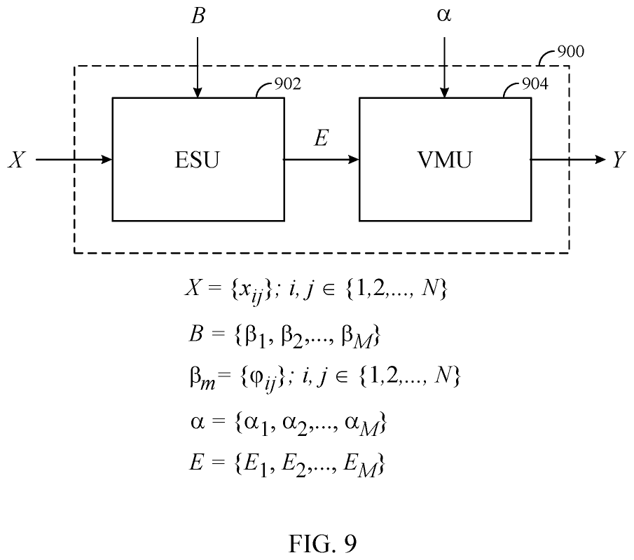

FIG. 9 depicts an example of a hardware accelerator 900 that is configured to perform sum-pooling operations efficiently. Because sum-pooling operations may not be highly optimized on traditional processing units, whereas other convolution operations may be, hardware accelerator 900 may be implemented to ensure that the theoretical model complexity and efficiency improvements described herein (e.g., with respect to composite kernels and sum-pooling operations) are achieved in actual processing hardware.

In the depicted example, hardware accelerator 900 includes an efficient extract sum unit (ESU), which takes the input data (e.g., activations) X and the basis masks (e.g., binary masks) βₘ and generates a sum-pooled output (or basis sum) E={Eₘ}, m∈{1, 2, . . . , M}.

Hardware accelerator 900 further includes an efficient variable-length vector multiplication unit (VMU) 704, which applies vectors of scaling factors α={α₁, α₂, . . . , α_{M}} to the sum-pooled output E to generate a scalar output Y.

Notably, accelerator 900 is configured to support variable-length vector inputs in both the ESU 902 and VMU 904. For example, ESU 902 may be configured based on the structure of the basis mask (e.g., βₘ), and VMU 904 may be configured based on the number of basis kernels (M). These configurations support efficient convolutions with composite kernels as well as structured convolutions, which have explicit square or cuboid structures. An example of an arbitrary composite kernel is depicted in FIG. 1A and an example of a structured composite kernel is depicted in FIG. 1B.

Both ESU 902 and VMU 904 are examples of special-purpose processing units configured to perform hardware-accelerated convolutions using composite kernels, including structured convolutions.

FIG. 10 depicts an example processing pipeline 1000 that may be implemented with the hardware accelerator 900 of FIG. 9. In particular, the processing pipeline 1000 is configured to exploit sum-pooling operations, including cross-stride and cross-kernel sum sharing, as described herein.

For operations in each stride i of a structured convolution, an ESU such as depicted in FIG. 9 computes all sum-pooled outputs Eᵢ before advancing to the next stride. Then, the sum-pooled outputs Eᵢ can be used by a VMU (e.g., 904 in FIG. 9) during the next stride to generate convolution layer outputs Yᵢ for i∈{1 . . . S}, where S is the total number of strides.

Notably, ESU operations 1002 and VMU operations 1004 are able to be performed in parallel with data associated with multiple strides being processed in the same time periods. This allows the sum-pooling outputs to be used across different operations without introducing latency in the overall convolution processing by having to store them in a buffer or other sort of memory. Rather, values may be stored in local registers. This streaming approach to processing the convolution data saves latency, memory use, and power, since writing to and retrieving from memory is a power sensitive operation.

### Example Methods

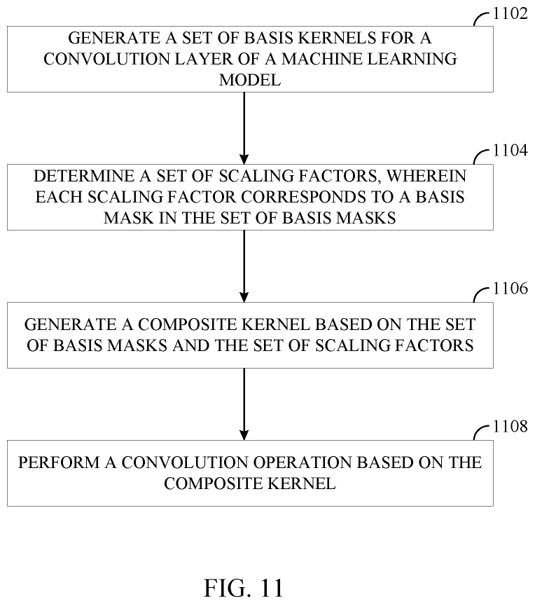

FIG. 11 depicts an example method 1100 of performing machine learning in accordance with various aspect described herein.

Method 1100 begins at step 1102 with generating a set of basis masks (e.g., βᵢ, i∈{1, . . . , M}) for a convolution layer of a machine learning model. In some aspects, each basis mask comprises a binary mask.

Method 1100 then proceeds to step 1104 with determining a set of scaling factors (e.g., αᵢ, i∈{1, . . . , M}, wherein each scaling factor of the set of scaling factors corresponds to a basis mask in the set of basis masks.

Method 1100 then proceeds to step 1106 with generating a composite kernel based on the set of basis masks and the set of scaling factors. For example, the composite kernel may be comprised of basis kernels defined by the set of basis masks and corresponding scaling factors, such as in the examples depicted in the examples of FIGS. 1A-1D.

Method 1100 then proceeds to step 1108 with performing a convolution operation based on the composite kernel, such as the example depicted in FIG. 3.

In some aspects, performing the convolution operation based on the composite kernel comprises: receiving input data; for each respective basis mask in the set of basis masks associated with the composite kernel: extracting a subset of the input data for processing based on the respective basis mask; computing a basis sum for the respective basis mask based on the subset of the input data for the respective basis mask; and computing a partial convolution layer output by applying a scaling factor corresponding to the respective basis mask to the basis sum; and generating a convolution layer output by summing each partial convolution layer output associated with each basis mask in the set of basis masks.

In some aspects, the composite kernel comprises a structured kernel; and the convolution operation comprises a structured convolution.

In some aspects, the convolution operation comprises: receiving input data; performing a sum-pooling operation on the input data to generate sum-pooled output data; and performing a convolution operation on the sum-pooled output data using a convolution kernel with spatial dimensions smaller than the spatial dimensions of the input data.

In some aspects, method 1100 further includes training the machine learning model with a structural regularization term, such as described with respect to FIG. 8.

In some aspects, method 1100 further includes training the machine learning model using a Toeplitz matrix based on the set of basis masks.

In some aspects, method 1100 further includes: applying a structural decomposition to the convolution layer to generate a decomposed convolution layer; and training the machine learning model using the decomposed convolution layer and a task loss function. In some aspects, the task loss function is Equation 3.

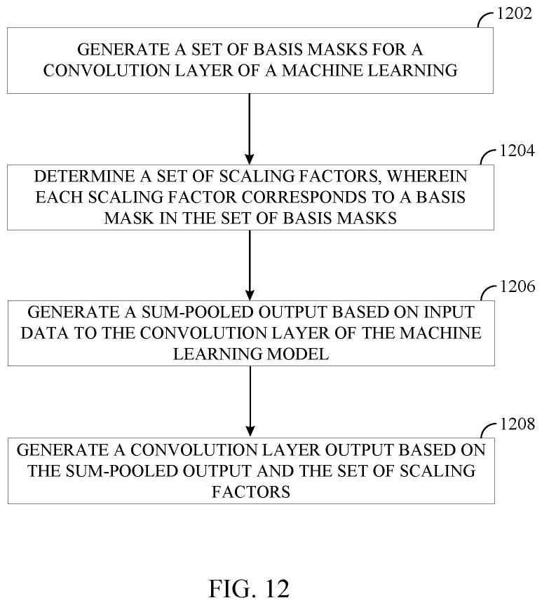

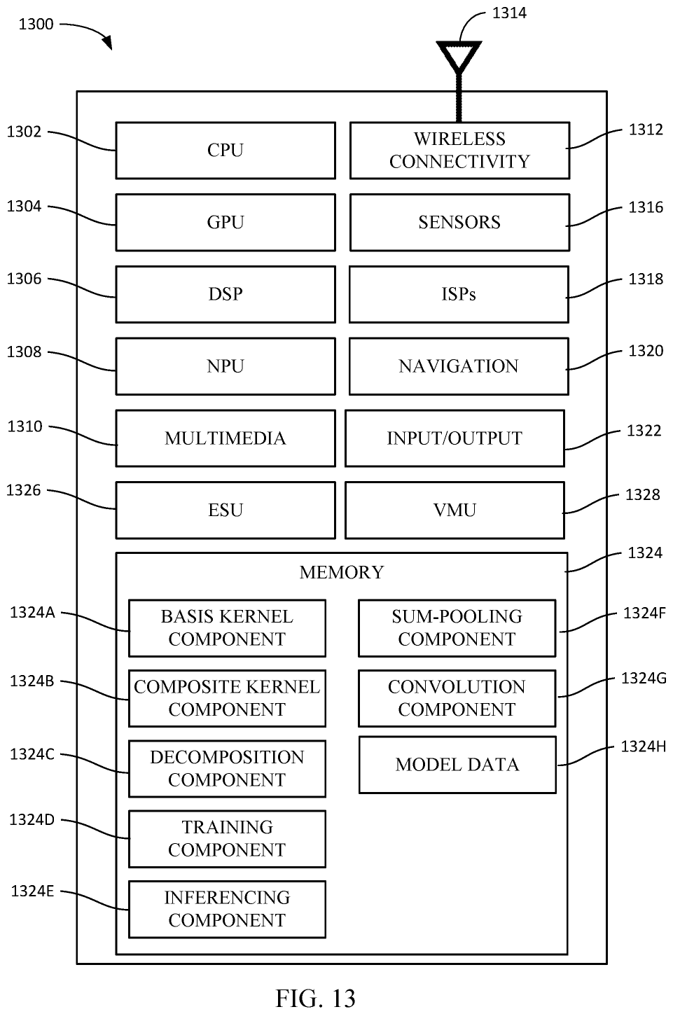

FIG. 12 depicts another example method 1200 of performing machine learning in accordance with various aspect described herein.

Method 1200 begins at step 1202 with generating a set of basis masks for a convolution layer of a machine learning model. In some embodiments, each basis mask comprises a binary mask.

Method 1200 then proceeds to step 1204 with determining a set of scaling factors, wherein each scaling factor of the set of scaling factors corresponds to a basis mask in the set of basis masks.

Method 1200 then proceeds to step 1206 with generating a sum-pooled output based on input data to the convolution layer of the machine learning model.

Method 1200 then proceeds to step 1208 with generating a convolution layer output based on the sum-pooled output and the set of scaling factors.

In some aspects, generating the sum-pooled output based on the input data to the convolution layer comprises: for each respective basis mask in the set of basis masks: extracting a subset of the input data for processing based on the respective basis mask; and computing the sum-pooled output for the respective basis mask based on the subset of input data for the respective basis mask.

In some aspects, generating the convolution layer output based on the sum-pooled output and the kernel comprising the scaling factors comprises multiplying the kernel comprising the scaling factors with the sum-pooled output.

In some aspects, generating the sum-pooled output based on the input data to the convolution layer is performed by an extract sum unit (ESU), and generating the convolution layer output based on the sum-pooled output and the kernel comprising the scaling factors is performed by a vector multiplication unit (VMU), such as described with respect to FIGS. 9 and 10.

In some aspects, the sum-pooled output is associated with a first stride of a structured convolution, the convolution layer output is associated with the first stride of the structured convolution, and the method further comprises generating a second sum-pooled output associated with a second stride of the structured convolution with the ESU concurrent with the VMU generating the convolution layer output associated with the first stride of the structured convolution, such as described with respect to FIG. 10.

In some aspects, method 1200 further includes configuring the ESU based on a structure of each basis mask in the set of basis masks.

In some aspects, method 1200 further includes configuring the VMU based on a number of basis masks in the set of basis masks.

In some aspects, generating the sum-pooled output comprises performing a cross-kernel sum sharing operation.

In some aspects, generating the sum-pooled output comprises performing a cross-stride sum sharing operation.

### Example Electronic Device for Performing Machine Learning

FIG. 13 depicts an example processing system 1300 for performing machine learning in accordance with various aspects described herein, such as described herein with respect to FIGS. 1A-12.

Electronic device 1300 includes a central processing unit (CPU) 1302, which in some examples may be a multi-core CPU. Instructions executed at the CPU 1302 may be loaded, for example, from a program memory associated with the CPU 1302 or may be loaded from a memory partition 1324.

Electronic device 1300 also includes additional processing components tailored to specific functions, such as a graphics processing unit (GPU) 1304, a digital signal processor (DSP) 1306, a neural processing unit (NPU) 1308, a multimedia processing unit 1310, and a wireless connectivity component 1312.

An NPU, such as 1308, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 1308, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 1308 may be integrated as a part of one or more of CPU 1302, GPU 1304, and/or DSP 1306.

In some examples, wireless connectivity component 1312 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 1312 is further connected to one or more antennas 1314.

Electronic device 1300 may also include one or more sensor processing units 1316 associated with any manner of sensor, one or more image signal processors (ISPs) 1318 associated with any manner of image sensor, and/or a navigation processor 1320, which may include satellite-based positioning system components (e.g., GPS or GLONASS) as well as inertial positioning system components.

Electronic device 1300 may also include one or more input and/or output devices 1322, such as screens, touch-sensitive surfaces (including touch-sensitive displays), physical buttons, speakers, microphones, and the like.

In some examples, one or more of the processors of electronic device 1300 may be based on an ARM or RISC-V instruction set.

Electronic device 1300 also includes extract-sum unit (ESU) 1326 and vector multiplication unit (VMU) 1328, which may collectively comprise a hardware accelerator for performing convolutions with composite kernels, including structured convolutions, as described above with respect to FIGS. 1A-12.

Electronic device 1300 also includes memory 1324, which is representative of one or more static and/or dynamic memories, such as a dynamic random access memory, a flash-based static memory, and the like. In this example, memory 1324 includes computer-executable components, which may be executed by one or more of the aforementioned processors of electronic device 1300.

In particular, in this example, memory 1324 includes basis kernel component 1324A, composite kernel component 1324B, decomposition component 1324C, training component 1324D, inferencing component parameters 1324E, sum-pooling component 1324F, convolution component 1324G, and model data 1324H. The depicted components, and others not depicted, may be configured to perform various aspects of the methods described herein.

Generally, electronic device 1300 and/or components thereof may be configured to perform the methods described herein.

Notably, in other cases, aspects of processing system 1300 may be omitted, such as where processing system 1300 is a server computer or the like. For example, multimedia component 1310, wireless connectivity 1312, sensors 1316, ISPs 1318, and/or navigation component 1320 may be omitted in other aspects. Further, aspects of processing system 1300 maybe distributed between multiple devices.

Notably, processing system 1300 is just one example, and others are possible.

### Example Clauses

Implementation examples are described in the following numbered clauses:

Clause 1: A method of performing machine learning, comprising: generating a set of basis masks for a convolution layer of a machine learning model, wherein each basis mask comprises a binary mask; determining a set of scaling factors, wherein each scaling factor of the set of scaling factors corresponds to a basis mask in the set of basis masks; generating a composite kernel based on the set of basis masks and the set of scaling factors; and performing a convolution operation based on the composite kernel.

Clause 2: The method of Clause 1, wherein performing the convolution operation based on the composite kernel comprises: receiving input data; for each respective basis mask in the set of basis masks associated with the composite kernel: extracting a subset of the input data for processing based on the respective basis mask; computing a basis sum for the respective basis mask based on the subset of the input data for the respective basis mask; and computing a partial convolution layer output by applying a scaling factor corresponding to the respective basis mask to the basis sum; and generating a convolution layer output by summing each partial convolution layer output associated with each basis mask in the set of basis masks.

Clause 3: The method of any one of Clauses 1-2, wherein: the composite kernel comprises a structured kernel; and the convolution operation comprises a structured convolution.

Clause 4: The method of Clause 3, wherein the convolution operation comprises: receiving input data; performing a sum-pooling operation on the input data to generate sum-pooled output data; and performing a convolution operation on the sum-pooled output data using a convolution kernel with spatial dimensions smaller than the spatial dimensions of the input data.

Clause 5: The method of any one of Clauses 1-4, further comprising training the machine learning model with a structural regularization term.

Clause 6: The method of any one of Clauses 1-5, further comprising training the machine learning model using a Toeplitz matrix based on the set of basis masks.

Clause 7: The method of any one of Clauses 1-6, further comprising: applying a structural decomposition to the convolution layer to generate a decomposed convolution layer; and training the machine learning model using the decomposed convolution layer and a task loss function.

Clause 8: A method for performing machine learning, comprising: generating a set of basis masks for a convolution layer of a machine learning model, wherein each basis mask comprises a binary mask; determining a set of scaling factors, wherein each scaling factor of the set of scaling factors corresponds to a basis mask in the set of basis masks; generating a sum-pooled output based on input data to the convolution layer of the machine learning model; and generating a convolution layer output based on the sum-pooled output and the set of scaling factors.

Clause 9: The method of Clause 8, generating the sum-pooled output based on the input data to the convolution layer comprises: for each respective basis mask in the set of basis masks: extracting a subset of the input data for processing based on the respective basis mask; and computing the sum-pooled output for the respective basis mask based on the subset of input data for the respective basis mask.

Clause 10: The method of Clause 9, wherein generating the convolution layer output based on the sum-pooled output and the kernel comprising the scaling factors comprises multiplying the kernel comprising the scaling factors with the sum-pooled output.

Clause 11: The method of Clause 10, wherein: generating the sum-pooled output based on the input data to the convolution layer is performed by an extract sum unit (ESU), and generating the convolution layer output based on the sum-pooled output and the kernel comprising the scaling factors is performed by a vector multiplication unit (VMU).

Clause 12: The method of Clause 11, wherein: the sum-pooled output is associated with a first stride of a structured convolution, the convolution layer output is associated with the first stride of the structured convolution, and the method further comprises generating a second sum-pooled output associated with a second stride of the structured convolution with the ESU concurrent with the VMU generating the convolution layer output associated with the first stride of the structured convolution.

Clause 13: The method of Clause 11, further comprising configuring the ESU based on a structure of each basis mask in the set of basis masks.

Clause 14: The method of Clause 13, further comprising configuring the VMU based on a number of basis masks in the set of basis masks.

Clause 15: The method of any one of Clauses 8-14, wherein generating the sum-pooled output comprises performing a cross-kernel sum sharing operation.

Clause 16: The method of any one of Clauses 8-14, wherein generating the sum-pooled output comprises performing a cross-stride sum sharing operation.

Clause 17: A processing system, comprising: a memory comprising computer-executable instructions; one or more processors configured to execute the computer-executable instructions and cause the processing system to perform a method in accordance with any one of Clauses 1-16.

Clause 18: A processing system, comprising means for performing a method in accordance with any one of Clauses 1-16.

Clause 19: A non-transitory computer-readable medium comprising computer-executable instructions that, when executed by one or more processors of a processing system, cause the processing system to perform a method in accordance with any one of Clauses 1-16.

Clause 20: A computer program product embodied on a computer-readable storage medium comprising code for performing a method in accordance with any one of Clauses 1-16.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
generating a set of basis masks for a convolution layer of a machine learning model, wherein each basis mask comprises a binary mask;
determining a set of scaling factors, wherein each scaling factor of the set of scaling factors corresponds to a basis mask in the set of basis masks;
generating a composite kernel based on the set of basis masks and the set of scaling factors; and
performing a convolution operation based on the composite kernel.

2. The method of claim 1, wherein performing the convolution operation based on the composite kernel comprises:
receiving input data;
for each respective basis mask in the set of basis masks associated with the composite kernel:
extracting a subset of the input data for processing based on the respective basis mask;
computing a basis sum for the respective basis mask based on the subset of the input data for the respective basis mask; and
computing a partial convolution layer output by applying a scaling factor corresponding to the respective basis mask to the basis sum; and
generating a convolution layer output by summing each partial convolution layer output associated with each basis mask in the set of basis masks.

3. The method of claim 1, wherein:
the composite kernel comprises a structured kernel; and
the convolution operation comprises a structured convolution.

4. The method of claim 3, wherein the convolution operation comprises:
receiving input data;
performing a sum-pooling operation on the input data to generate sum-pooled output data; and
performing a convolution operation on the sum-pooled output data using a convolution kernel with spatial dimensions smaller than the spatial dimensions of the input data.

5. The method of claim 1, further comprising training the machine learning model with a structural regularization term.

6. The method of claim 1, further comprising training the machine learning model using a Toeplitz matrix based on the set of basis masks.

7. The method of claim 1, further comprising:
applying a structural decomposition to the convolution layer to generate a decomposed convolution layer; and
training the machine learning model using the decomposed convolution layer and a task loss function.

8. A processing system, comprising:
a memory comprising computer-executable instructions;
one or more processors configured to execute the computer-executable instructions and cause the processing system to:
generate a set of basis masks for a convolution layer of a machine learning model, wherein each basis mask comprises a binary mask;
determine a set of scaling factors, wherein each scaling factor of the set of scaling factors corresponds to a basis mask in the set of basis masks;
generate a composite kernel based on the set of basis masks and the set of scaling factors; and
perform a convolution operation based on the composite kernel.

9. The processing system of claim 8, wherein in order to perform the convolution operation based on the composite kernel, the one or more processors are further configured to cause the processing system to:
receive input data;
for each respective basis mask in the set of basis masks associated with the composite kernel:
extract a subset of the input data for processing based on the respective basis mask;
compute a basis sum for the respective basis mask based on the subset of the input data for the respective basis mask; and
compute a partial convolution layer output by applying a scaling factor corresponding to the respective basis mask to the basis sum; and
generate a convolution layer output by summing each partial convolution layer output associated with each basis mask in the set of basis masks.

10. The processing system of claim 8, wherein:
the composite kernel comprises a structured kernel; and
the convolution operation comprises a structured convolution.

11. The processing system of claim 10, wherein in order to perform the structured convolution operation, the one or more processors are further configured to cause the processing system to:
receive input data;
perform a sum-pooling operation on the input data to generate sum-pooled output data; and
perform a convolution operation on the sum-pooled output data using a convolution kernel with spatial dimensions smaller than the spatial dimensions of the input data.

12. The processing system of claim 8, wherein the one or more processors are further configured to cause the processing system to train the machine learning model with a structural regularization term.

13. The processing system of claim 8, wherein the one or more processors are further configured to cause the processing system to train the machine learning model using a Toeplitz matrix based on the set of basis masks.

14. The processing system of claim 8, wherein the one or more processors are further configured to cause the processing system to:
apply a structural decomposition to the convolution layer to generate a decomposed convolution layer; and
train the machine learning model using the decomposed convolution layer and a task loss function.

15. A non-transitory computer-readable medium comprising instructions that, when executed by one or more processors of a processing system, cause the processing system to perform a method of machine learning, the method comprising:
generating a set of basis masks for a convolution layer of a machine learning model, wherein each basis mask comprises a binary mask;
determining a set of scaling factors, wherein each scaling factor of the set of scaling factors corresponds to a basis mask in the set of basis masks;
generating a composite kernel based on the set of basis masks and the set of scaling factors; and
performing a convolution operation based on the composite kernel.

16. The non-transitory computer-readable medium of claim 15, wherein performing the convolution operation based on the composite kernel comprises:
receiving input data;
for each respective basis mask in the set of basis masks associated with the composite kernel:
extracting a subset of the input data for processing based on the respective basis mask;
computing a basis sum for the respective basis mask based on the subset of the input data for the respective basis mask; and
computing a partial convolution layer output by applying a scaling factor corresponding to the respective basis mask to the basis sum; and
generating a convolution layer output by summing each partial convolution layer output associated with each basis mask in the set of basis masks.

17. The non-transitory computer-readable medium of claim 15, wherein:
the composite kernel comprises a structured kernel; and
the convolution operation comprises a structured convolution.

18. The non-transitory computer-readable medium of claim 17, wherein the convolution operation comprises:
receiving input data;
performing a sum-pooling operation on the input data to generate sum-pooled output data; and
performing a convolution operation on the sum-pooled output data using a convolution kernel with spatial dimensions smaller than the spatial dimensions of the input data.

19. The non-transitory computer-readable medium of claim 15, wherein the method further comprises training the machine learning model with a structural regularization term.

20. The non-transitory computer-readable medium of claim 15, wherein the method further comprises training the machine learning model using a Toeplitz matrix based on the set of basis masks.

21. The non-transitory computer-readable medium of claim 15, wherein the method further comprises:
applying a structural decomposition to convolution layer to generate a decomposed convolution layer; and
training the machine learning model using the decomposed convolution layer and a task loss function.

22. A method, comprising:
generating a set of basis masks for a convolution layer of a machine learning model, wherein each basis mask comprises a binary mask;
determining a set of scaling factors, wherein each scaling factor of the set of scaling factors corresponds to a basis mask in the set of basis masks;
generating a sum-pooled output based on input data to the convolution layer of the machine learning model; and
generating a convolution layer output based on the sum-pooled output and the set of scaling factors.

23. The method of claim 22, generating the sum-pooled output based on the input data to the convolution layer comprises:
for each respective basis mask in the set of basis masks:
extracting a subset of the input data for processing based on the respective basis mask; and
computing the sum-pooled output for the respective basis mask based on the subset of the input data for the respective basis mask.

24. The method of claim 23, wherein generating the convolution layer output based on the sum-pooled output and the kernel comprising the scaling factors comprises multiplying the kernel comprising the scaling factors with the sum-pooled output.

25. The method of claim 24, wherein:
generating the sum-pooled output based on the input data to the convolution layer is performed by an extract sum unit (ESU), and
generating the convolution layer output based on the sum-pooled output and the kernel comprising the scaling factors is performed by a vector multiplication unit (VMU).

26. The method of claim 25, wherein:
the sum-pooled output is associated with a first stride of a structured convolution,
the convolution layer output is associated with the first stride of the structured convolution, and
the method further comprises generating a second sum-pooled output associated with a second stride of the structured convolution with the ESU concurrent with the VMU generating the convolution layer output associated with the first stride of the structured convolution.

27. The method of claim 25, further comprising configuring the ESU based on a structure of each basis mask in the set of basis masks.

28. The method of claim 27, further comprising configuring the VMU based on a number of basis masks in the set of basis masks.

29. The method claim 22, wherein generating the sum-pooled output comprises performing a cross-kernel sum sharing operation.

30. The method of claim 22, wherein generating the sum-pooled output comprises performing a cross-stride sum sharing operation.
